(19) United States
(12) Patent Application Publication
(10) Pub. No.: US 2020/0115545 A1
(43) Pub. Date: Apr. 16, 2020

(54) BIODEGRADABLE POLYESTER FABRIC AND PREPARATION METHODS THEREOF

(71) Applicant: Paradise Textiles Ltd, Wuxi (CN)

(72) Inventors: Sandeep Kumar Tiwari, Singapore (SG); Cui Jing, Wuxi (CN); Li Shu Qing, Wuxi (CN); Sunil Prakash, Wuxi (CN); Ashok Mahtani, Singapore (SG)

(73) Assignee: Paradise Textiles Ltd, Wuxi (CN)

(21) Appl. No.: 16/220,493

(22) Filed: Dec. 14, 2018

(30) Foreign Application Priority Data
Oct. 10, 2018 (CN) 201811187689.8

(51) Int. Cl. C08L 67/02; C08J 3/22; C08J 11/10; D01F 6/84; D01F 1/06; D01F 1/10

(52) U.S. Cl. CPC C08L 67/02; C08J 3/226; C08J 11/10; D01F 6/84; D01F 1/06; D10B 2401/12; C08L 2203/12; C08L 2201/06; C08L 2205/025; C08L 2310/00; D01F 1/10

(57) ABSTRACT

A biodegradable polyester fabric and preparation methods thereof are disclosed. A biodegradable additive is added to PET (Polyethylene Terephthalate) to allow rapid biodegradation of a textile material in soil, achieving the advantages of environment protection and the like. In addition, different raw materials can be selected for the PET. When recyclable PET bottles, PET packages or polyester fabrics are selected, the waste PET bottles, PET packages or polyester fabrics can be recycled and reused to prepare a biodegradable type of product, which not only reduces economic cost but also achieves multiple advantages such as environmental protection. For the biodegradable polyester fabric, a dye additive can also be added while adding the biodegradable additive to prepare a dye-doped biodegradable polyester fabric, thereby preventing the production of dye wastewater to achieve the purpose of environment protection and moreover, to reduce the preparation cost, with a new biodegradable polyester fabric obtained.

### BACKGROUND OF THE INVENTION

### 1. Technical Field

The invention relates to the field of textiles, and in particular to a biodegradable polyester fabric and preparation methods thereof.

### 2. Description of Related Art

With the gradual improvement of the quality of life of people, the application of high-performance textiles gradually has spread to every area of the life of people, and consequently, a large number of waste from high-performance textiles have been produced. In a general sense, textile wastes mainly include: scraps produced due to chemical and mechanical actions in a textile process; waste yarns and hard wastes produced during spinning production and leftover bits and pieces produced during tailoring; and textile fibers and products thereof as well as threads, ropes, cords, cables and the like discarded in residential life and other activities.

However, as the requirements for environmental protection and recycling increase, the biodegradability of textile materials has become one of the research hotspots at present.

### BRIEF SUMMARY OF THE INVENTION

An object of the invention is to provide a biodegradable polyester fabric which has the advantages of environmental friendliness, economy, cost saving and the like.

To achieve the object above, the invention provides a biodegradable polyester fabric, comprising PET (Polyethylene Terephthalate) and a biodegradable additive, wherein the PET is refined from crude oil, and the biodegradable additive is mixed particles of aliphatic-aromatic ester, modified polylactides, organoleptic monosaccharides and aldohexoses.

The invention further provides a biodegradable polyester fabric, comprising PET and a biodegradable additive, wherein the PET is recycled from recyclable PET bottles, PET packages or polyester fabrics, and the biodegradable additive is mixed particles of aliphatic-aromatic ester, modified polylactides, organoleptic monosaccharides and aldohexoses.

The invention further provides another biodegradable polyester fabric, which is characterized by comprising PET, a dye additive and a biodegradable additive, wherein the PET is refined from crude oil or recycled from recyclable PET bottles or polyester fabrics, and the biodegradable additive is mixed particles of aliphatic-aromatic ester, modified polylactides, organoleptic monosaccharides and aldohexoses.

Preferably, the content of the biodegradable additive is 0.1% w/w-5% w/w.

The invention further provides a preparation method for a biodegradable polyester fabric, which comprises the steps of: providing pure PET master batches; melting the pure PET master batches, and adding a biodegradable additive or adding the biodegradable additive and a dye additive simultaneously; and preparing biodegradable yarns, and then knitting/weaving to obtain the biodegradable polyester fabric.

Preferably, a preparation method for the pure PET master batches comprises the steps of: providing a PET raw material; melting and depolymerizing the PET raw material to obtain DMT (Dimethyl Terephthalate) and EG (Ethylene Glycol); and purifying the DMT, adding the pure EG for polymerization to obtain pure PET, and preparing the pure PET master batches.

Preferably, the PET raw material is crushed before melting.

The invention further provides a preparation method for a biodegradable polyester fabric, which comprises the steps of: providing a PET raw material, and crushing and cleaning the PET raw material to obtain PET debris; melting the PET debris, adding a biodegradable additive or adding the biodegradable additive and a dye additive, and then spinning to obtain the biodegradable polyester fabric; or melting the PET debris to prepare PET master batches, melting the PET master batches, adding the biodegradable additive or adding the biodegradable additive and the dye additive, and then spinning to obtain the biodegradable polyester fabric.

Compared with the prior art, the invention mainly has the following advantageous effect: the biodegradable additive is added to the PET to allow rapid biodegradation of the textile material in soil, achieving the advantages of environment protection and the like.

Further, different raw materials can be selected for the PET. When recyclable PET bottles, PET packages or polyester fabrics are selected, the waste PET bottles, PET packages or polyester fabrics can be recycled and reused to prepare a biodegradable type of product, which not only reduces economic cost but also achieves multiple advantages such as environment protection. In addition, for the biodegradable polyester fabric of the invention, a dye additive can also be added while adding the biodegradable additive to prepare a dye-doped biodegradable polyester fabric, thereby preventing the production of dye wastewater to achieve the purpose of environment protection and moreover, to reduce the preparation cost, with a new biodegradable polyester fabric obtained.

### BRIEF DESCRIPTION OF THE DRAWINGS

FIG. 1 is a schematic view illustrating a structure for preparing a textile material chemically in Embodiment 1 of the invention; and

FIG. 2 is a schematic view illustrating a structure for preparing a textile material physically in Embodiment 2 of the invention.

### DETAILED DESCRIPTION OF THE INVENTION

A biodegradable polyester fabric and preparation methods thereof provided by the invention are described in more detail below with reference to the accompanying drawings, in which preferred embodiments of the invention are illustrated. It should be understood that the advantageous effects of the invention can be achieved even if a person of ordinary skill in the art may modify the description of the invention here. Therefore, the following description should be understood as being widely known to a person of ordinary skill in the art, and should not be construed as a limit to the invention.

The invention provides a biodegradable polyester fabric, comprising PET (Polyethylene Terephthalate) extracted from crude oil, and a biodegradable additive, wherein the biodegradable additive is mixed particles of aliphatic-aromatic ester, modified polylactides, organoleptic monosaccharides and aldohexose.

Specifically, the content of the biodegradable additive is 0.1% w/w-5% w/w, for example, 0.5% w/w, 1% w/w, 1.5% w/w, 2% w/w, 3% w/w or 4% w/w. The content of the biodegradable additive can determine the level of degradability without affecting the performance of a prepared textile material.

### Embodiment 1

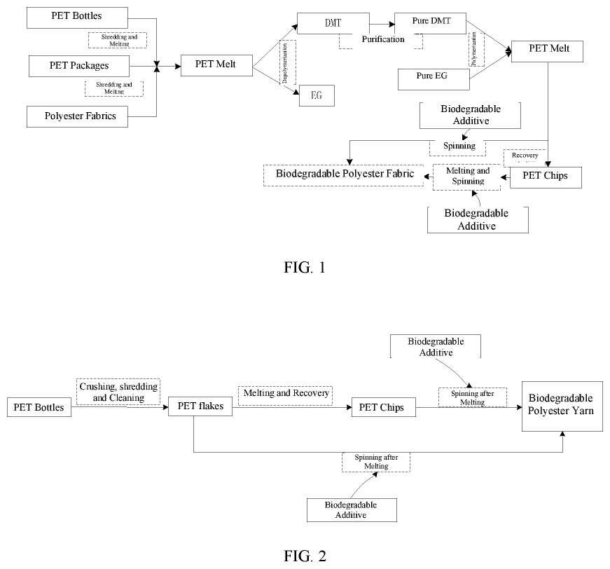

In this embodiment, the PET is refined from crude oil. With reference to FIG. 1, a preparation method (also referred to as a chemical preparation method) for the biodegradable polyester fabric comprises the steps of: providing pure PET master batches; melting the pure PET master batches, and adding a biodegradable additive; and preparing degradable yarns, and then weaving to obtain the biodegradable polyester fabric.

Specifically, a preparation method for the pure PET master batches comprises the steps of: providing a PET raw material (including PET bottles, polyester packaging and recyclable raw materials such as polyester fabric; melting and depolymerizing the PET raw material to obtain DMT (Dimethyl Terephthalate) and EG (Ethylene Glycol); and purifying the DMT, adding the pure EG for polymerization to obtain pure PET, and preparing the pure PET master batches.

The PET raw material is crushed, molten and then depolymerized to obtain the DMT and EG, and the DMT is purified and then added to the pure EG for polymerization to obtain the pure PET, which can ensure to provide a pure PET material.

The addition of the biodegradable additive to the PET allows the rapid biodegradation of a textile material in soil, achieving the advantages of environment protection and the like.

### Embodiment 2

With reference to FIG. 2, the PET raw material in this embodiment comprises a recyclable PET material such as PET bottles. Based on this material, another preparation method (also referred to as a physical preparation method) for the biodegradable polyester fabric is provided with lower preparation cost, which comprises the steps of: providing a PET raw material, and crushing and cleaning the PET raw material to obtain PET flakes; melting the PET flakes, adding a biodegradable additive, and then spinning to obtain the biodegradable polyester yarn; or melting the PET flakes to prepare PET master batches, melting the PET master batches, adding the biodegradable additive, and then spinning to obtain the biodegradable polyester yarn.

Certainly, a person of ordinary skill in the art should understand that the recyclable PET material such as PET bottles, PET packages and polyester fabrics can also be cleaned to be used for the chemical preparation method in Embodiment 1. Refer to Embodiment 1 for the specific process, which will not be elaborated here. In this embodiment, the recyclable PET bottles, PET packages or polyester fabrics are selected for the PET. The waste PET bottles, PET packages or polyester fabrics can be recycled and reused to prepare a biodegradable type of product, which not only reduces economic cost but also achieves multiple advantages such as environment protection.

### Embodiment 3

In this embodiment, the biodegradable polyester fabric is prepared substantially the same as that in Embodiments 1 and 2, with a difference only in that a dye is further added besides the biodegradable additive, therefore, the prepared biodegradable polyester fabric is dope-dyed.

Specifically in the preparation process, the dye additive can be added while the biodegradable additive is added, and then spinning is performed to prepare a dye-doped biodegradable polyester fabric.

Above all, according to the biodegradable polyester fabric and the preparation method thereof provided in this embodiment, the dye additive can also be added for the biodegradable polyester fabric in this embodiment while adding the biodegradable additive to prepare a dye-doped biodegradable polyester fabric, thereby preventing the production of dye wastewater to achieve the purpose of environment protection and moreover to reduce the preparation cost, with a new biodegradable polyester fabric obtained.

A biodegradable polyester fabric and preparation methods thereof are disclosed. A biodegradable additive is added to PET (Polyethylene Terephthalate) to allow rapid biodegradation of a textile material in soil, achieving the advantages of environment protection and the like. In addition, different raw materials can be selected for the PET. When recyclable PET bottles, PET packages or polyester fabrics are selected, the waste PET bottles, PET packages or polyester fabrics can be recycled and reused to prepare a biodegradable type of product, which not only reduces economic cost but also achieves multiple advantages such as environmental protection. For the biodegradable polyester fabric, a dye additive can also be added while adding the biodegradable additive to prepare a dye-doped biodegradable polyester fabric, thereby preventing the production of dye wastewater to achieve the purpose of environment protection and moreover, to reduce the preparation cost, with a new biodegradable polyester fabric obtained.

One embodiment include a biodegradable polyester yarn and fabric, comprising: PET (Polyethylene Terephthalate); and a biodegradable additive, wherein the PET is refined from crude oil, and the biodegradable additive is mixed particles of aliphatic-aromatic ester, modified polylactides, organoleptic monosaccharides and aldohexose.

One embodiment include a biodegradable polyester yarn and fabric, comprising: PET; and a biodegradable additive, wherein the PET is recycled from recyclable PET bottles, PET packages or polyester fabrics, and the biodegradable additive is mixed particles of aliphatic-aromatic ester, modified polylactides, organoleptic monosaccharides and aldohexose.

One embodiment include a biodegradable polyester yarn and fabric, comprising: PET; a dye additive; and a biodegradable additive, wherein the PET is refined from crude oil or recycled from recyclable PET bottles or polyester fabrics, and the biodegradable additive is mixed particles of aliphatic-aromatic ester, modified polylactides, organoleptic monosaccharides and aldohexose.

One embodiment includes a preparation method for a biodegradable polyester fabric, comprising the steps of: providing pure PET master batches; melting the pure PET master batches, and adding a biodegradable additive or adding the biodegradable additive and a dye additive simultaneously; and preparing degradable yarns, and then weaving to obtain the biodegradable polyester fabric.

One embodiment includes a preparation method for a biodegradable polyester fabric, comprising the steps of: providing a PET raw material, and crushing and cleaning the PET raw material to obtain PET debris; melting the PET debris, adding a biodegradable additive or adding the biodegradable additive and a dye additive, and then spinning to obtain the biodegradable polyester fabric; or melting the PET debris to prepare PET master batches, melting the PET master batches, adding the biodegradable additive or adding the biodegradable additive and the dye additive, and then spinning to obtain the biodegradable polyester fabric.

The description above merely shows the preferred embodiments of the invention, and should not be construed as a limit to the invention. Any equivalent substitutions or changes or other variations, made to the technical solution and content disclosed in the invention by any people of ordinary skills in the art without departing from the scope of the technical solution of the invention, shall be construed as pertaining to the technical solution of the invention, and shall fall within the protection scope of the invention.

What is claimed is:

1. Biodegradable polyester yarn and fabric, comprising:
PET (Polyethylene Terephthalate); and
a biodegradable additive, wherein the PET is refined from crude oil, and the biodegradable additive is mixed particles of aliphatic-aromatic ester, modified polylactides, organoleptic monosaccharides and aldohexose.

2. The biodegradable polyester fabric of claim 1, wherein:
the content of the biodegradable additive is 0.1% w/w-5% w/w.

3. Biodegradable polyester yarn and fabric, comprising:
PET; and
a biodegradable additive, wherein the PET is recycled from recyclable PET bottles, PET packages or polyester fabrics, and the biodegradable additive is mixed particles of aliphatic-aromatic ester, modified polylactides, organoleptic monosaccharides and aldohexose.

4. The biodegradable polyester fabric of claim 3, wherein:
the content of the biodegradable additive is 0.1% w/w-5% w/w.

5. Biodegradable polyester yarn and fabric, comprising:
PET;
a dye additive; and
a biodegradable additive, wherein the PET is refined from crude oil or recycled from recyclable PET bottles or polyester fabrics, and the biodegradable additive is mixed particles of aliphatic-aromatic ester, modified polylactides, organoleptic monosaccharides and aldohexose.

6. The biodegradable polyester fabric of claim 5, wherein:
the content of the biodegradable additive is 0.1% w/w-5% w/w.

7. A preparation method for a biodegradable polyester fabric, comprising the steps of:
providing pure PET master batches;
melting the pure PET master batches, and adding a biodegradable additive or adding the biodegradable additive and a dye additive simultaneously; and
preparing degradable yarns, and then weaving to obtain the biodegradable polyester fabric.

8. The preparation method for the biodegradable polyester fabric of claim 7, wherein a preparation method of the pure PET master batches comprises the steps of:
providing a PET raw material;
melting and depolymerizing the PET raw material to obtain DMT (Dimethyl Terephthalate) and EG (Ethylene Glycol); and
purifying the DMT, adding the pure EG for polymerization to obtain pure PET, and preparing the pure PET master batches.

9. The preparation method for the biodegradable polyester fabric of claim 8, wherein the PET raw material is crushed before melting.

10. A preparation method for a biodegradable polyester fabric, comprising the steps of:
providing a PET raw material, and crushing and cleaning the PET raw material to obtain PET debris; and
melting the PET debris, adding a biodegradable additive or adding the biodegradable additive and a dye additive, and then spinning to obtain the biodegradable polyester fabric;
or melting the PET debris to prepare PET master batches, melting the PET master batches, adding the biodegradable additive or adding the biodegradable additive and the dye additive, and then spinning to obtain the biodegradable polyester fabric.
